(19) United States
(12) Patent Application Publication
(10) Pub. No.: US 2010/0049589 A1
(43) Pub. Date: Feb. 25, 2010

(54) ISSUER DEVICE SUPPORT OF AN INTEGRATED OFFER NETWORK

(75) Inventor: Howard Scott Debow, Piedmont, CA (US)

Correspondence Address: TOWNSEND AND TOWNSEND CREW LLP, TWO EMBARCADERO CENTER, 8TH FLOOR, SAN FRANCISCO, CA, 94111, US

(73) Assignee: VISA USA, INC., SAN FRANCISCO, CA (US)

(21) Appl. No.: 12/413,075

(22) Filed: Mar. 27, 2009

Related U.S. Application Data
(60) Provisional application No. 61/091,422, filed on Aug. 24, 2008.
(60) Provisional application No. 61/091,425, filed on Aug. 24, 2008.

(51) Int. Cl. G06Q 30/00; G06Q 10/00; G06Q 40/00; G06F 15/16

(52) U.S. Cl. 705/10; 705/80; 709/206; 705/14.14

(57) ABSTRACT

A method begins by determining option criteria for a group of transactional cards. The method continues by providing the option criteria to a transactional processing entity device. The method continues by receiving, from the transaction processing entity device, a plurality of options that are in accordance with the option criteria. The method continues by processing a selection of at least one of the plurality of options to create an options data file for the group of transactional cards. The method continues by providing the options data file to the transactional processing entity device.

### CROSS-REFERENCE TO RELATED PATENTS

This patent application shares a common Specification and figures with the following co-pending patent applications filed on the same day as the present patent application:
1. U.S. Utility Application No. TBD, entitled “Transactional Processing Entity Device Support of an Integrated Offer Network”, filed TBD (Attorney Docket No. P-14218US), which is a non-provisional of U.S. Provisional Application No. 61/091,422, entitled “Transactional Processing Entity Device Support of an Integrated Offer Network” filed Aug. 24, 2008; and
2. U.S. Utility Application No. TBD, entitled “Merchant Device Support of an Integrated Offer Network”, filed TBD (Attorney Docket No. P-14218US2), which is a non-provisional of U.S. Provisional Application No. 61/091,425, entitled “Merchant Device Support of an Integrated Offer Network” filed Aug. 24, 2008.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISC

Not applicable.

### BACKGROUND OF THE INVENTION

1. Technical Field of the Invention

This invention relates generally to financial transaction processing systems and more particularly to incentive offers, services, and/or features within such systems.

2. Description of related art

Millions of credit card transactions are accurately processed every day regardless of whether the purchaser is making a purchase in his/her home town, in another part of the world, or via the internet. Each transaction has a two stage process: authorization and clearing & settlement. Authorization is the process of approving or declining the transaction at the commencement of the transaction and clearing & settlement is the process of making the payment and accounting for the payment.

The authorization process begins when a point-of-sale terminal (physical for in-store purchases, virtual for internet purchases) reads a purchaser's credit card information and obtains a transaction amount. The terminal transmits the credit card information and the transaction amount to an acquirer bank, which combines the credit card information and the transaction amount into an authorization request. The acquirer bank transmits the authorization request to a proprietary transaction processing network (e.g., VisaNet®), which routes the authorization request to an issuer bank (i.e., the bank that issued the credit card). Alternatively, the proprietary transaction processing network may perform a stand-in review and authorization.

When the authorization request is sent to the issuer bank, the bank, or a designated third party, reviews the request and approves or denies it. The issuer bank transmits a response to the proprietary transaction processing network indicating its decision. The proprietary transaction processing network forwards the response to the acquirer bank, which in turn, forwards the response to the point-of-sale terminal.

The clearing & settlement process begins with clearing, which, in turn, begins when the point-of-sale terminal, or other merchant processing device, transmits sales draft information (e.g., account numbers and amounts) to the acquirer bank. The acquirer bank formats the sales draft information into a clearing message that it transmits to the proprietary transaction processing network. The network transmits the clearing message to the issuer bank, which calculates settlement obligations of the issuer bank, processing fees, and the amount due the acquirer bank. Settlement begins when the issuer bank transmits funds to a designated bank of the proprietary transaction processing network, which, after processing, transfers the funds to the acquirer bank.

In an alternate credit card transaction processing system, the proprietary transaction network is owned by a single issuer bank. Thus, in contrast with the previously described system, the alternative system includes only one issue bank, not a large number of issuer banks, and, as such, the issuer bank's functions and the proprietary transaction network functions previously discussed are merged. In this alternate system, the processing of the single issuer is less than the multiple issuer system but creates a processing bottleneck due to the single issuer.

Regardless of the type of credit card transaction processing system, such systems provides consumers, whether individuals, small companies, or large corporate entities, an easy mechanism for paying for goods and/or services. In an effort to promote use of credit cards for purchasing goods and/or services, issuers, merchants, and/or the transactional processing entities (e.g., Visa®) offer a variety of incentive programs. For example, a transaction processing entity may offer incentive programs relating to a particular merchant, by a particular category of goods and/or services from some merchants, by a type of incentive program (e.g., free shipping), and/or by features (e.g., lost/stolen card reporting). As another example, merchant's may offer discounts, free shipping, save $X on purchases greater than $Y, etc. As yet another example, an issuer may offer features such as Z % annual bonus, AA % reward on travel or entertainment, etc.

Such merchant offers, issuer features, and/or transactional processing entity services are managed in multiple areas of a financial transaction processing system due to different incentive programs targeting different market needs for issuers and/or merchants. As such, there are many incentive program opportunities for merchants and/or issuers to participate in, but do not because they are unaware of them or are unable to access them due to the multiple area management.

Therefore, a need exists for a method and apparatus of providing an integrated offers, features, and/or services.

### BRIEF DESCRIPTION OF THE SEVERAL VIEWS OF THE DRAWINGS

FIG. 1 is a schematic block diagram of an embodiment of a financial transaction processing system in accordance with the present invention;

FIG. 2 is a diagram of an example of an integrated collection of offers, features, and/or services in accordance with the present invention;

FIG. 3 is a diagram of an example of transactional processing entity selected offers, features, and/or services made available to an issuer in accordance with the present invention;

FIG. 4 is a diagram of an example of issuer selected offers made available to a first group of transactional cards in accordance with the present invention;

FIG. 5 is a diagram of an example of selected offers made by a card holder of the first group of transactional cards in accordance with the present invention;

FIG. 6 is a diagram of an example of issuer selected offers and/or features made available to a second group of transactional cards in accordance with the present invention;

FIG. 7 is a diagram of an example of selected offers and/or features made by a card holder of the second group of transactional cards in accordance with the present invention;

FIG. 8 is a diagram of an example of issuer selected offers, features, and/or services made available to a third group of transactional cards in accordance with the present invention;

FIG. 9 is a diagram of an example of selected offers, features, and/or services made by a card holder of the third group of transactional cards in accordance with the present invention;

FIG. 10 is a diagram of another example of transactional processing entity selected offers, features, and/or services made available to an issuer in accordance with the present invention;

FIG. 11 is a diagram of another example of issuer selected offers made available to a first group of transactional cards in accordance with the present invention;

FIG. 12 is a diagram of another example of selected offers made by a card holder of the first group of transactional cards in accordance with the present invention;

FIG. 13 is a diagram of another example of issuer selected offers made available to a third group of transactional cards in accordance with the present invention;

FIG. 14 is a diagram of another example of selected offers made by a card holder of the third group of transactional cards in accordance with the present invention;

FIG. 15 is a schematic block diagram of an embodiment of an issuer device in accordance with the present invention;

FIG. 16 is a logic diagram of an embodiment of a method in accordance with the present invention;

FIG. 17 is a logic diagram of a further embodiment of a method in accordance with the present invention;

FIG. 18 is a logic diagram of another further embodiment of a method in accordance with the present invention; and

FIGS. 19 and 20 are a logic diagram of another embodiment of a method in accordance with the present invention.

### DETAILED DESCRIPTION OF THE INVENTION

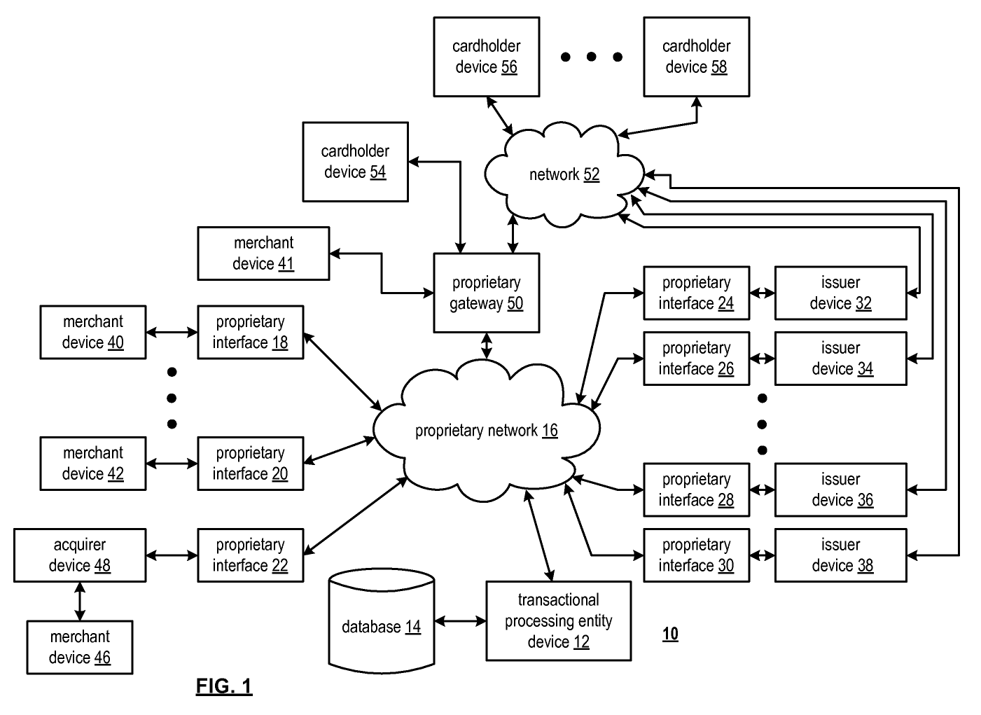

FIG. 1 is a schematic block diagram of an embodiment of a financial transaction processing system 10 that includes that includes a financial transaction entity device 12, a database 14, a proprietary network 16, a plurality of proprietary interfaces 18-30, a plurality of issuer devices 32-38, a plurality of merchant devices 40-46, one or more acquirer devices 48, a proprietary gateway 50, a network 52 (e.g., the internet), and a plurality of cardholder devices 54-58. A merchant device 40-46 may be associated with one or more merchants that sells products and/or services. Such a merchant may have a single locally owned store, a chain of stores located any where in the world, and/or an e-business. An issuer device 32-38 is associated with an issuer of one or more types of credit cards (e.g., personal, business, pre-paid, debit, auto pay, single use, various status levels, customized logo, etc.).

The payment entity device 12, the database 14, and the proprietary network 16 may be operated and maintained by a single transactional processing entity to facilitate integration of offers, features, and/or services. For example, Visa, Inc. may provide its VisaNet® as the proprietary network 16 and have one or more computing devices (e.g., computers, servers, super computers, main frames, etc.) coupled to the proprietary network 16 to function as the transactional processing entity device 12, which may have one or more databases 14 coupled thereto.

In general, the transaction processing entity device 12 communicates with one or more of the plurality of merchant devices 40-46 to collect offers they support. For example, the offers may be product related (e.g., buy a specific pair of jeans, get five dollars off), may be product category related (e.g., buy golf merchandise, get ten percent off), may be service related (e.g., eye exam for seventy-five dollars); may be service category related (e.g., accounting services), may be generic (e.g., get two percent off on all purchases; get free shipping with purchases greater than fifty dollars; save fifteen dollars on purchases greater than two hundred dollars, etc.), may be consumer type related (e.g., men age 20-35; women age 20-35; golf enthusiasts; apparel enthusiasts, etc.), may be credit card status related (e.g., pre-paid, business, debit, gold status, platinum, etc.), may be card issuer related (e.g., Bank A issued cards, Bank C issued cards, etc.), may be location related (e.g., all California stores; all San Jose, Calif. stores; a specific store; etc.), and/or may be combinations (e.g., buy first eye wear at full price, get second one for half price; buy product X, get product Z for free).

The communication between the transactional processing entity device 12 and one or more of the merchant devices 40-46 may occur via the proprietary network 16 and a proprietary interface 18-22 or via the proprietary network 16 and the proprietary gateway 50. For example, merchant device 40 communicates with the transactional processing entity device 12 via proprietary interface 18 and the proprietary network 16. Note that the proprietary interface 18-22 is a proprietary node, modem, bridge, etc., that serves as a private connection point to the proprietary network 16, which ensures that only the associated device (e.g., merchant device 40 for interface 18) has access to the proprietary network 16.

As another example, merchant device 46 may communicate with the transactional processing entity device 12 via an acquirer device 48, which is coupled to a proprietary interface 22. In this example, the acquirer device 48 functions as a communication relay between the merchant device 46 and the transactional processing entity device 12. Note that the merchant device 46 may be coupled to the acquirer device 48 via the network 52.

As a further example, example, merchant device 41 communicates with the transactional processing entity device 12 via the proprietary gateway 26 and the proprietary network 16. The proprietary gateway 26 is a proprietary node, modem, bridge, etc., that serves as a public connection point to the proprietary network 16, which ensures that only authorized entities have access to the proprietary network 16. Note that communications within the system 10 occur in accordance with the communication protocol (e.g., internet protocol, transmission control protocol, and/or a proprietary version thereof) of the proprietary network 16.

In addition to communicating with the merchant devices 40-46, the transactional processing entity device 12 communicates with the issuer devices 32-38 to determine the issuer's offer type preferences or criteria. For example, the issuer may request a general level of offers that it will use to select specific offer programs for various groups of cards (e.g., gold, platinum, a company card, a consumer enthusiast card [e.g., tennis], a gas card, etc.). The general level of offer criteria may include one or more generic offers from some or all of the merchants, specific products and/or product categories from some or all of the merchants, specific services and/or services categories from some or all of the merchants, etc. In this instance, the transactional processing entity device 12 compiles the list of offers in accordance with these criteria and provides a corresponding list of offers data file to the issuer device.

As another example, the issuer may request a specific level of offers for a specific group of credit cards (e.g., cards with Company A's logo). The specific level of offers requested may be for one or more offers supported by Company A. In this instance, the transactional processing entity device 12 compiles offers supported by Company A and provides a corresponding list of offers data file to the issuer device.

The issuer device 32-38 processes the list of offers for a given group of cards (e.g., gold card, cards with Company A's logo, etc.) to produce a list of available offers for the given group. The list of available offers may be provided to the transactional processing entity device 12 and/or may be maintained by the issuer device 32-38.

A cardholder of a card in the given group accesses the list of available offers via a cardholder device 54-58 from the transactional processing entity device 12 and/or the issuer device 32-38. Once accessed, the cardholder device 54-58 selects one or more of the available options for its card and provides the selection(s) to the transactional processing entity device 12 (and to the issuer device 32-38). The transactional processing entity device 12 stores the selections for use when transactions are processed for the card.

When a transaction is processed for the card, the transactional processing entity device 12 retrieves the selected offer or offers and processes the transaction in accordance therewith. For example, if the selected offer is $10 off with a purchase of $75 or more, the transactional processing entity device determines when a transaction amount for the card exceeds $75. If not, the $10 off is not applied. If the transaction amount is greater than $75, the transactional processing entity device 12 processes the transaction with the $10 off applied.

In addition to offering its cardholders offers from various merchants, an issuer can offer issuer features and/or transactional processing entity services. Issuer features include, but are not limited to, one or more of annual fees, introductory annual percentage rate (APR), a fixed APR, a variable APR, cash back on purchases, reward points, and fund transfers. Transactional processing entity services include, but are not limited to, one or more of auto rental collision damage waiver, cardholder inquiry service, emergency cash disbursement, card replacement, lost/stolen card reporting, zero liability, lost luggage reimbursement, purchase security, rewards program, roadside dispatch, travel assistance, emergency assistance, travel accident insurance, sports and entertainment services, concierge services, warranty management, exclusive shopping, and year end summary reporting.

If an issuer offers its cardholders in a specific group of cards issuer features and/or transactional processing entity services, the features and/or services are included in the list of available offers. In addition to selecting one or more offers, the cardholder device 54-58 may select one or more of the available issuer features and/or transactional processing entity services for its card. The cardholder device 54-58 provides the selection(s) to the transactional processing entity device 12 (and maybe to the issuer device 32-38). The transactional processing entity device 12 stores the selections for use when transactions are processed for the card.

As the transactional processing entity device 12 is processing transactions for a variety of cards, it monitors one or more of, but not limited to, the type of purchases, the amount of purchases, the use of selected offers, features, and/or services for the purchases, type status or type of card, cardholder data, frequency of use, and time of day of purchase. From this data, the transactional processing entity device can generate recommended offers for individual merchants, can generate recommended features for individual issuers, and can generate recommended services for the transactional processing entity. The recommendations may include adding a new offer, feature, and/or service; deleting an offer, feature, and/or service; and/or modifying an offer, feature, and/or service. In addition, the transactional processing entity device 12 may generate a list of recommended offers, features, and/or services for an individual cardholder based on the collected transactional data.

In addition, the transactional processing entity device may automatically update the offers supported by the merchant, the list of offers provided to the issuer, the list of available offers, features, and/or services provided to the cardholder as new offers, features, and/or services become available, as offers, features, and/or services change, and/or as offers, features, and/or services expire. In this regard, merchants, issuers, and/or cardholder are provided with a centrally managed and maintained database of offers, features, and/or services, which benefits merchants of any size by getting their offers to a wider audience, which benefits issuers by having a centralized database of merchant offers that can be integrated with its features and/or transactional processing entity services, and which benefits cardholders by having a wide variety of offers, features, and/or services to select.

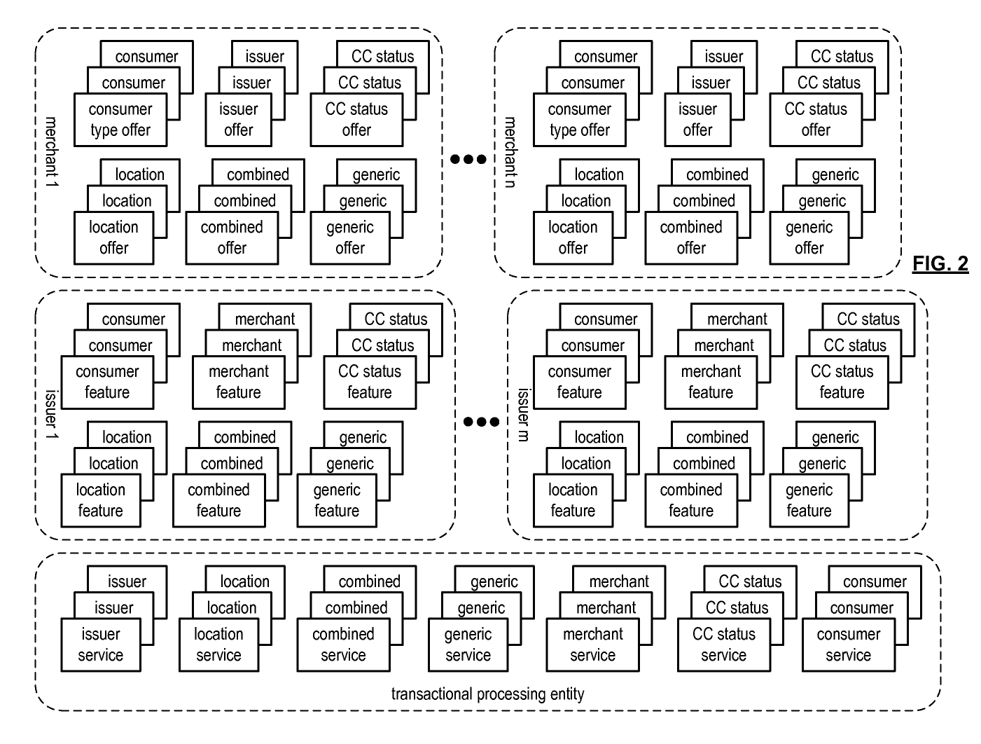

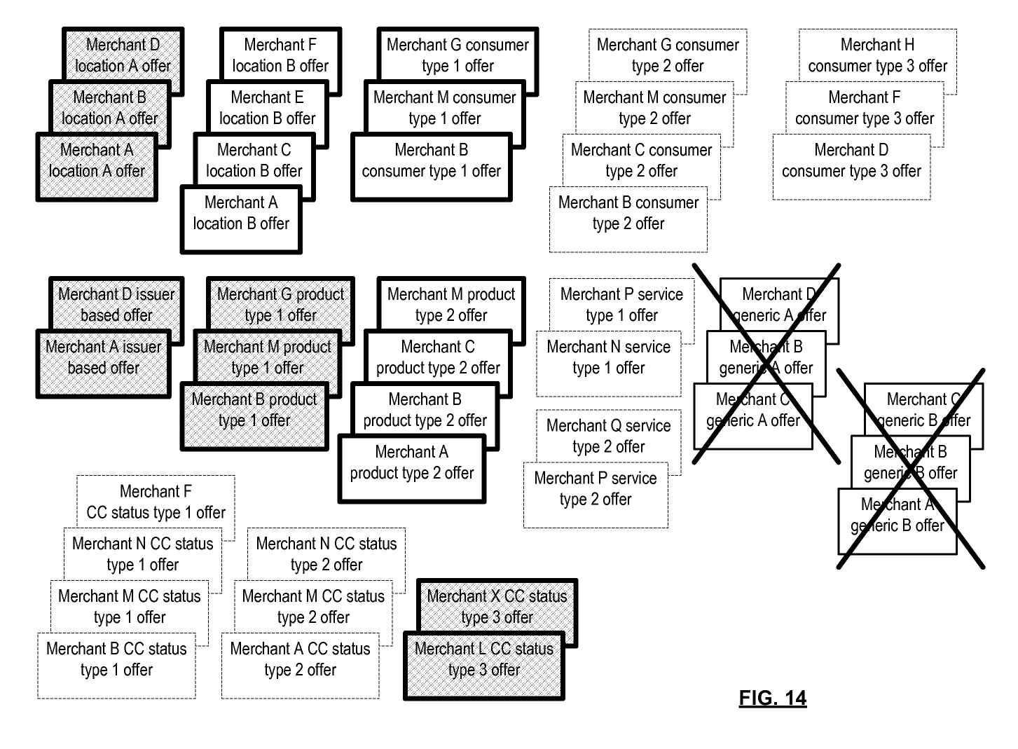

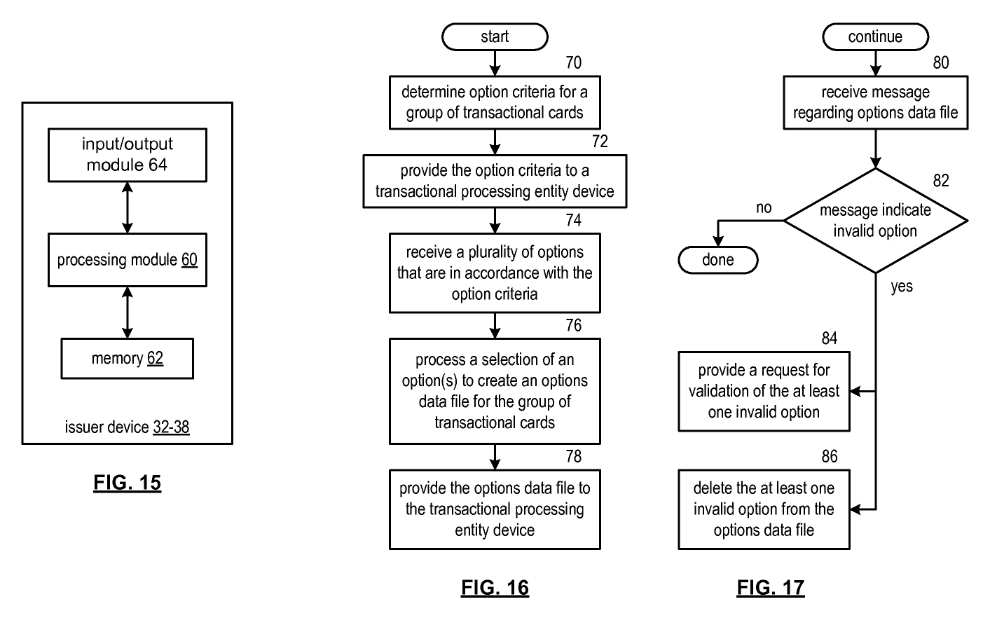

FIG. 2 is a diagram of an example of an integrated collection of offers, features, and/or services collected by the transactional processing entity device 12. In this example, the transactional processing entity device 12 has communicated with a plurality of merchant devices 40-46 (e.g., merchant 1 through merchant n) to collect their merchants' offers. The collection of offers will be discussed in greater detail with reference to FIGS. 15-18 and 22-29. The offers may be one or more consumer type based offers (e.g., special sales and/or discounts for men, women, children, cardholders that spend more that X per month on a credit card, sports enthusiast, apparel enthusiast, etc.), one or more issuer related offers (e.g., card issued from Bank Q, get 1% discount), one or more credit cardholder status based offers (e.g., gold status get 1% discount, platinum status get 2% discount, etc.), one or more location specific offers (e.g., get 5% off all purchases made at store X in City Y, State Z, get 2% off of purchases made in stores in City AA, State BB, etc.), one or more combined offers (e.g., which provides restrictions for which offers can be combined and/or lists specific offers that are combined), and/or one or more generic offers (e.g., 1 merchant bonus point for each dollar spent; $10 off of purchases greater than $75; free shipping with purchases greater than $100; 10% for purchases made between 2-5 PM eastern time, etc.).

In this example, the transactional processing entity device 12 organizes the offers based on the merchant supporting them. Alternatively, the transactional processing entity device 12 may organize the offers based on the type of offer (e.g., generic, consumer specific, issuer, credit card status, etc.), based on value of the offer, and/or any other desired segmentation of the offers.

The transactional processing entity device 12 may also store issuer features supported by a plurality of issuer devices (e.g., issuer 1 through issuer m). In this example, the transactional processing entity device 12 has communicated with a plurality of issue devices 32-38 to collect their issuers' features. The collection of features will be discussed in greater detail with reference to FIGS. 15-21. The issuer features may include one or more of, but not limited to, consumer type features (e.g., various annual APR, reward points, etc. for cardholders spending more that X per month on a credit card, sports enthusiast, apparel enthusiast, etc.), merchant features (e.g., buy from Merchant A, get 2× reward points), credit cardholder status features (e.g., additional various reward points based on status, various APR based on status, various annual fees based on status, etc.), location features (e.g., use at home get X reward points, use while traveling get Y reward points, etc.), combined features (e.g., which provides restrictions for which features can be combined and/or lists specific features that are combined), and generic features (e.g., basic reward programs).

The transactional processing entity device 12 may further store the services its transactional processing entity supports. Such services include one or more of, but are not limited to, issuer specific services (e.g., use Bank 1 credit card, get free purchase security), location specific services (e.g., use in US, get free road side assistance), combined services (e.g., which provides restrictions for which services can be combined and/or lists specific services that are combined), generic services (e.g., available for all cards and may include auto rental car collision damage waiver, cardholder inquiry service, emergency cash disbursement, card replacement, lost/stolen card reporting, etc), merchant specific services (e.g., purchase from merchant A, get exclusive shopping options), credit card status services (e.g., first level get generic services, second level gets basic plus second level services, third level gets lower level services plus third level services [e.g., Visa Signature® card]), and/or consumer type services (e.g., travel assistance for travel enthusiasts, sports and entertainment ticket services for such enthusiasts, etc.).

The transactional processing entity device 12 may continually, or periodically, update the merchant offers, issuer features and/or services with new, modified or expired offers, features, and/or services. Such updating requires communication with the corresponding merchant devices 40-46 and/or issuer devices 32-38 as will be discussed in greater detail below.

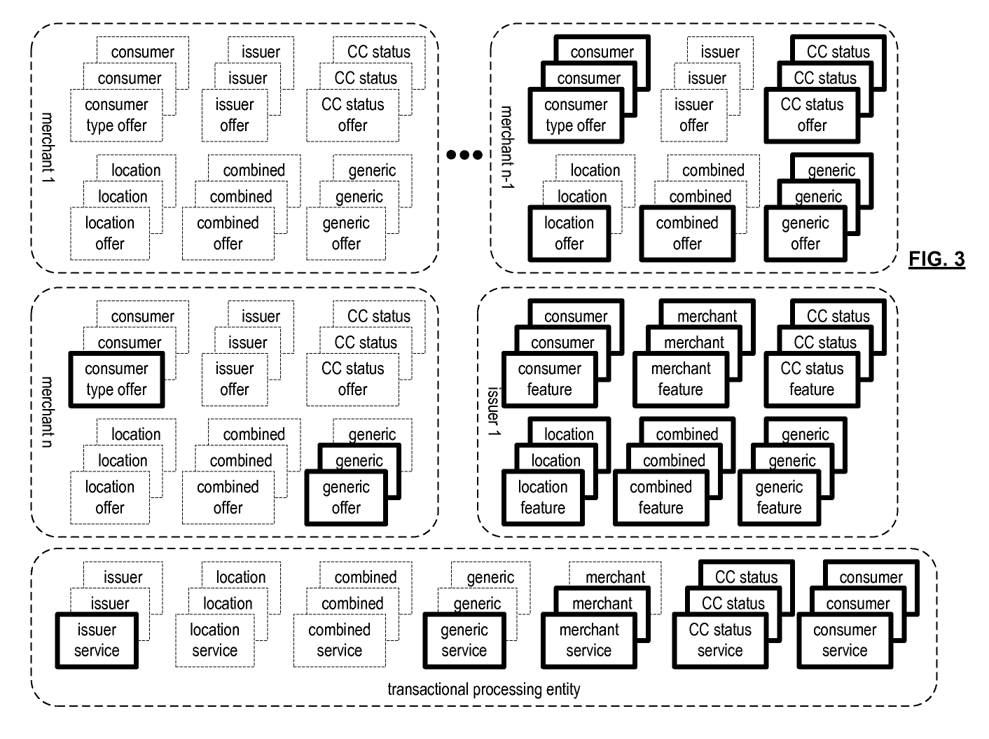

FIG. 3 is a diagram of an example of transactional processing entity device providing selected offers, features, and/or services to an issuer device in accordance with the issuer's offer criteria. In this example, the transactional processing entity device 12 takes the data in compiled in the example of FIG. 2 and filters it based on the issuer's offer criteria. The offer criteria may exclude any offers supported by Merchant 1 and any issuer based offers. The offer criteria may further include offers for specific consumer types, for specific locations, credit card status, and/or generic offers. In this example, the offers that are provided to the issuer are shown in bold lines while the offers that were filtered out based on the offer criteria are shown in light-dashed lines.

In addition to providing offers in accordance with the offer criteria, which may be for a specific group of cards or for several groups of cards that the issuer will parse prior to making them available to the cardholders, the transactional processing entity device 12 provides the issuer with the features stored by the transactional processing entity device 12.

Further, the transactional processing entity device 12 may select one or more transactional processing entity services to provide to the issuer device based on issuer's offer criteria. In this example, the transactional processing entity device 12 filters its services to yield one issuer based service, one generic service, a pair of merchant based services (excludes any services related to Merchant 1), a plurality of credit card status services, and a plurality of consumer type services. Note that is just an example and any number of offers, features, and/or services may be provided to the issuer device.

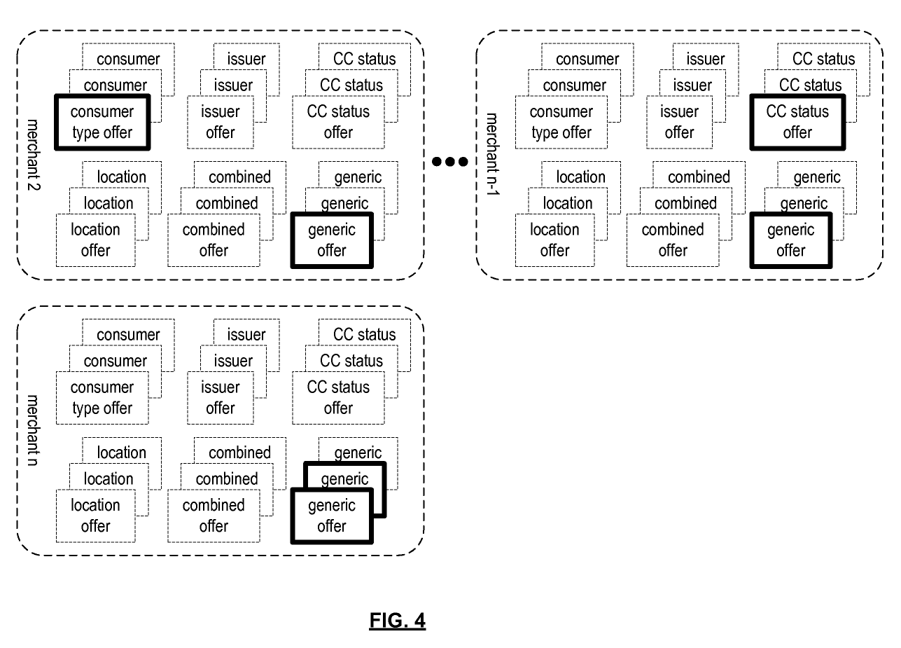

FIG. 4 is a diagram of an example of issuer selected offers made available to a first group of transactional cards. In this example, the issuer device is only allowing offers to be selected by cardholders of a card in the first group of transactional cards. Further, the issuer device has selected just few of the offers (i.e., the ones with bold lines) it was provided by the transactional processing entity device in FIG. 3 for selection by credit cardholders of the first group. These selections are provided to the transactional processing entity device 12 along with the identity of the issuer and the card information regarding the transactional cards in the first group. The transactional processing entity device 12 stores this information and awaits communication from a cardholder device 54-58 associated with a card in the first group. As an alternative, the transactional processing entity device 12 may generate the available offers for the issuer based on group specific offer criteria and provide the available offers to the issuer device.

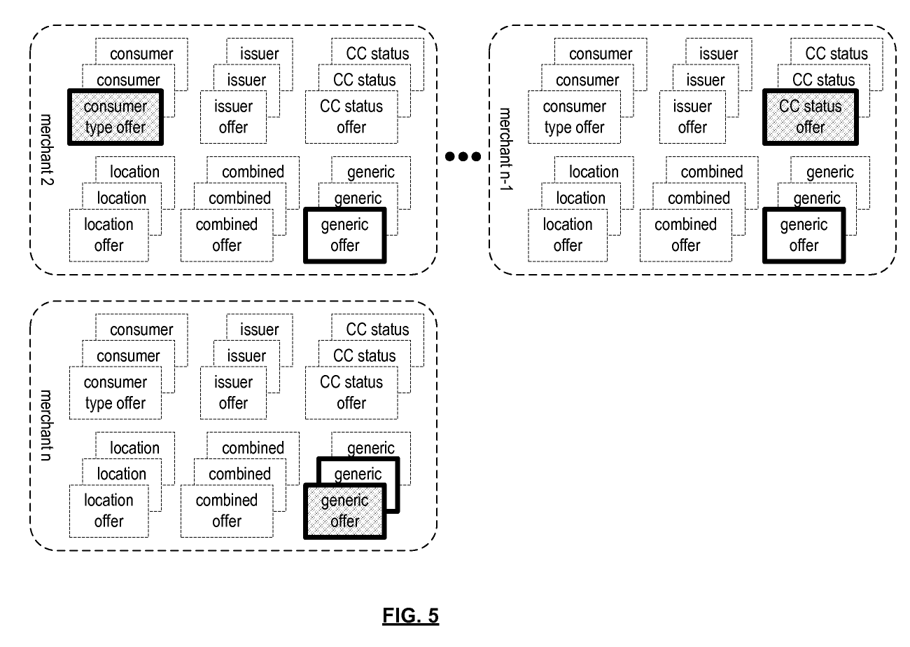

FIG. 5 is a diagram of an example of selected offers made by a card holder of the first group of transactional cards. In this example, a cardholder device 54-58 is communicating with the transactional processing entity device 12 to select one or more of the available offers. In this example, the gray shaded offers have been selected via the credit cardholder device 54-58. The transactional processing entity device 12 stores the selections for use when processing transactions of the card associated with the credit cardholder device 54-58.

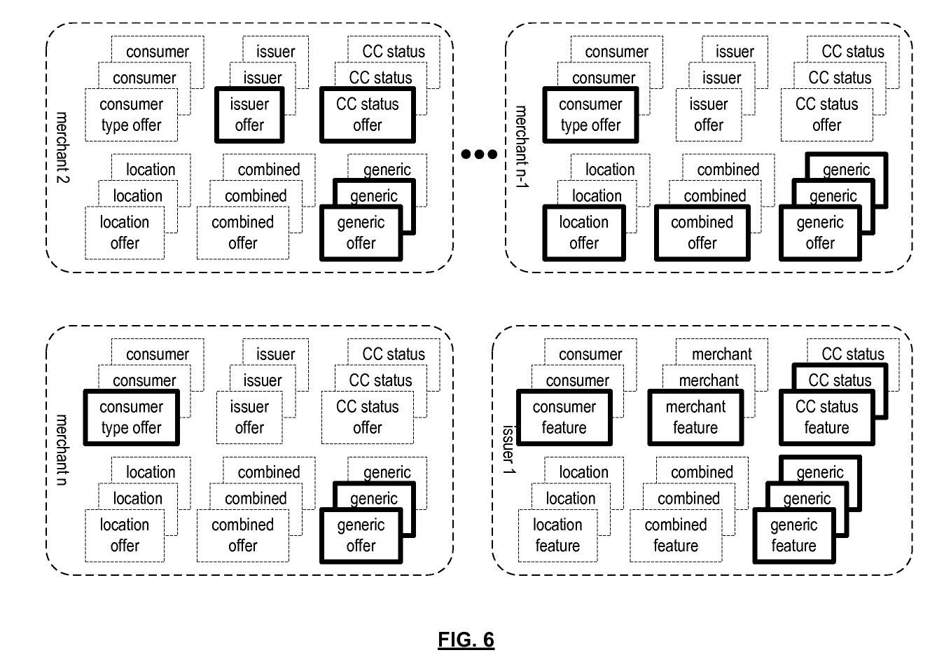

FIG. 6 is a diagram of an example of issuer selected offers and features made available to a second group of transactional cards, which is of a higher status than the first group. In this example, the issuer device is allowing offers and issuer features to be selected by cardholders of a card in the second group of transactional cards. The available offers and features are shown with bold lines while unavailable offers and features are shown with light-dashed lines. The selections of available offers and features are provided to the transactional processing entity device 12 along with the identity of the issuer and the card information regarding the transactional cards in the second group. The transactional processing entity device 12 stores this information and awaits communication from a cardholder device 54-58 associated with a card in the second group. As an alternative, the transactional processing entity device 12 may generate the available offers and/or features for the issuer based on group specific offer criteria and provide the available offers to the issuer device.

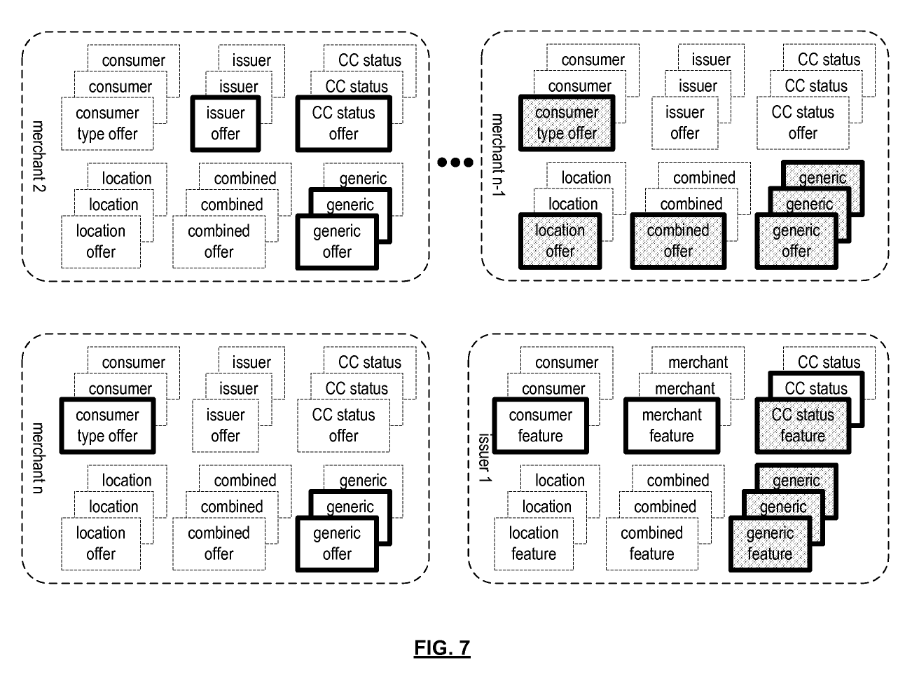

FIG. 7 is a diagram of an example of selected offers made by a card holder of the second group of transactional cards. In this example, a cardholder device 54-58 is communicating with the transactional processing entity device 12 to select one or more of the available offers and/or one or more of the available features. In this example, the gray shaded offers and features have been selected via the credit cardholder device 54-58. The transactional processing entity device 12 stores the selections for use when processing transactions of the card associated with the credit cardholder device 54-58.

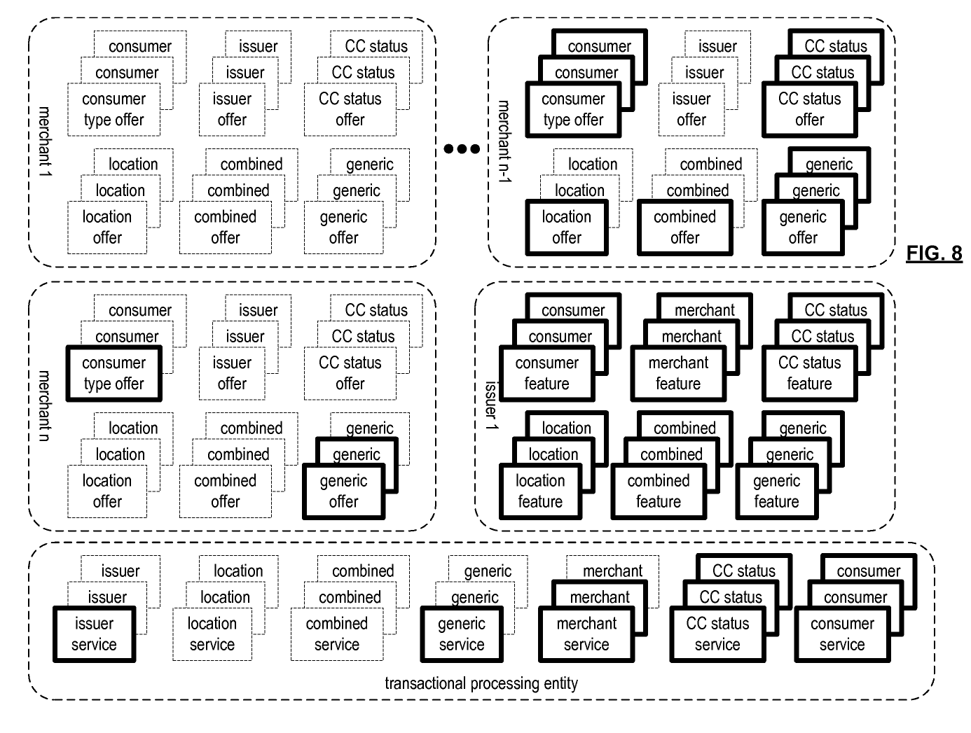

FIG. 8 is a diagram of an example of issuer selected offers, features, and services made available to a third group of transactional cards, which is of a higher status than the first and second groups. In this example, the issuer device is allowing offers, issuer features, and transactional processing entity services to be selected by cardholders of a card in the third group of transactional cards. The available offers, features, and services are shown with bold lines while unavailable offers, features, and services are shown with light-dashed lines. The selections of available offers, features, and services are provided to the transactional processing entity device 12 along with the identity of the issuer and the card information regarding the transactional cards in the third group. The transactional processing entity device 12 stores this information and awaits communication from a cardholder device 54-58 associated with a card in the third group. As an alternative, the transactional processing entity device 12 may generate the available offers, features, and/or services for the issuer based on group specific offer criteria and provide the available offers to the issuer device.

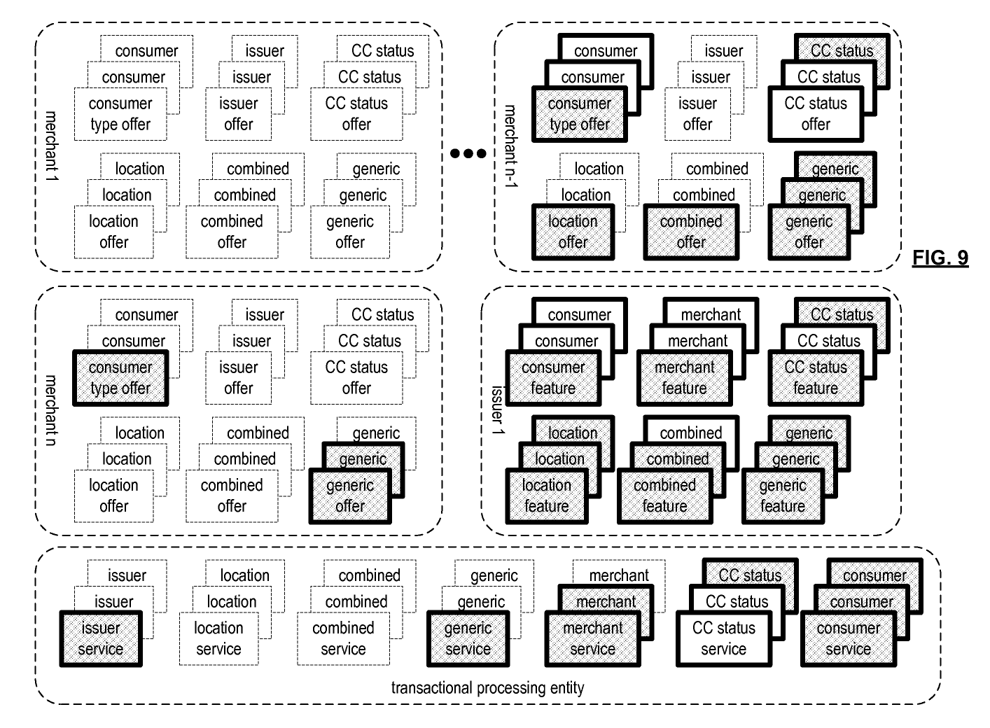

FIG. 9 is a diagram of an example of selected offers made by a card holder of the third group of transactional cards. In this example, a cardholder device 54-58 is communicating with the transactional processing entity device 12 to select one or more of the available offers, one or more of the available features, and/or one or more of the available services. In this example, the gray shaded offers, features, and services have been selected via the credit cardholder device 54-58. The transactional processing entity device 12 stores the selections for use when processing transactions of the card associated with the credit cardholder device 54-58.

As illustrated in the examples of FIGS. 2-9, the transactional processing entity device 12 provides a centralized repository of offers, features, and/or services that can be made available to cardholders via an associated issuer. In addition, the offers and/or services may be made available to cardholder devices by the transactional processing entity device 12 with little or no involvement of the issuer device 32-38.

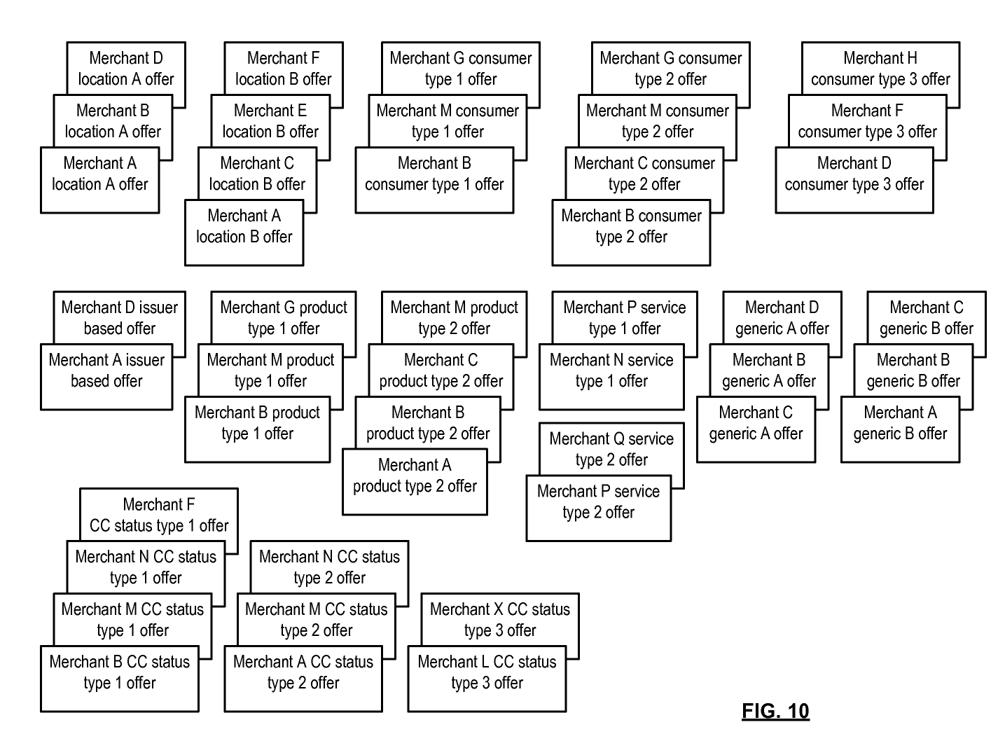

FIG. 10 is a diagram of another example of transactional processing entity device providing offers, features, and/or services to an issuer device. In this example, the transactional processing entity device 12 has taken the data of FIG. 3 (i.e., the example offers, features, and services that are in accordance with the issuer's offer criteria) and organized it based on type of offers, features, and/or services. For example, one grouping of offers may be for a specific location (e.g., location A [e.g., United States], which includes offers from Merchants A, B, and D) and a second grouping of offers may be for a second specific location (e.g., location B [e.g., California], which includes offers from Merchants A, C, E, and F). Such location specific offers may be for a particular type of product in a particular location. For example, one offer may relate to pick-up trucks in Texas and another offer may relate to hybrid cars in California.

As another example, offers may be grouped based on consumer types (e.g., type 1, 2, 3, etc.). For instance, consumer type 1 may be for men ages 35-50, consumer type 2 may be for women ages 35-50, and consumer type 3 may be for consumers with specific purchase habits (e.g., spends more than X per month an a credit card) and/or special interests (e.g., golf, movies, clothing, shoes, etc.). Other groupings of offers may be made based on merchant-issuer relationship, product type, service type, generic offer type, and credit card status. Note that more or less groupings may be made from the example categories and that more or less categories may be used to group the offers. Further note that an issuer may select a group of offers, individual offers, or any other combination of offers for a particular group of cards.

FIG. 11 is a diagram of another example of issuer selected offers made available to a first group of transactional cards. In this example, the issuer device has taken the data of FIG. 10 and selected two groups of offers (e.g., credit card status type 1 and generic B) for cards in the first group. These selections are provided to the transactional processing entity device 12 along with the identity of the issuer and the card information regarding the transactional cards in the first group. The transactional processing entity device 12 stores this information and awaits communication from a cardholder device 54-58 associated with a card in the first group. As an alternative, the transactional processing entity device 12 may generate the available offers for the issuer based on group specific offer criteria and provide the available offers to the issuer device.

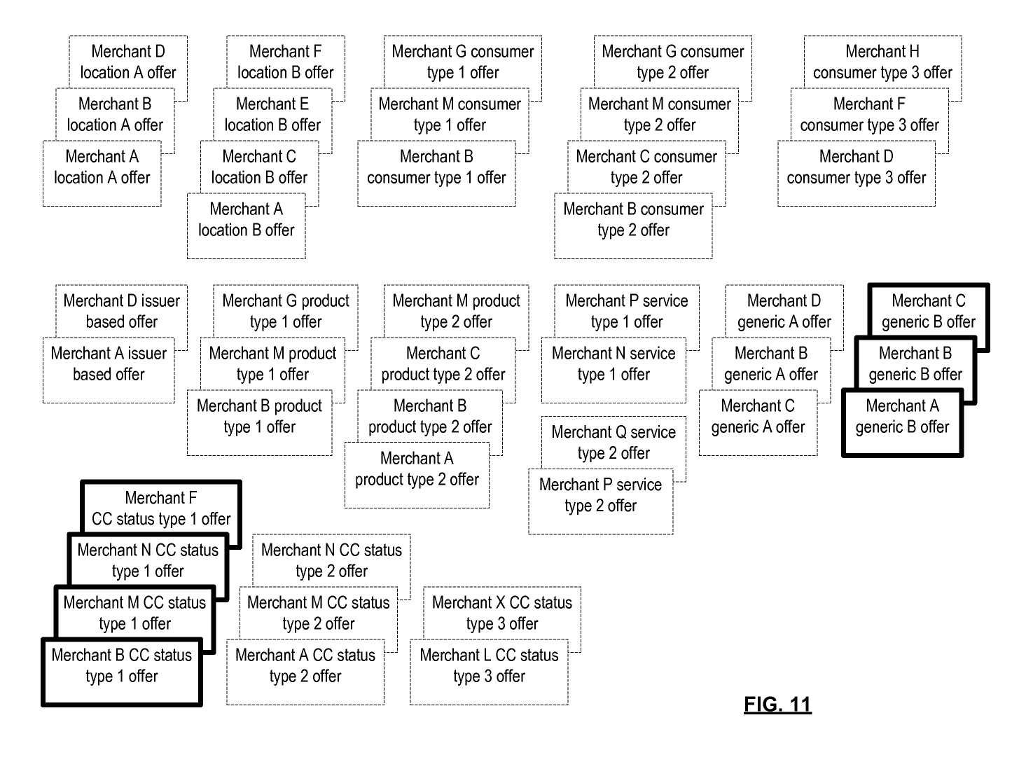

FIG. 12 is a diagram of an example of selected offers made by a card holder of the first group of transactional cards. In this example, a cardholder device 54-58 is communicating with the transactional processing entity device 12 to select one or more of the available offers. In this example, the gray shaded offers have been selected via the credit cardholder device 54-58. The transactional processing entity device 12 stores the selections for use when processing transactions of the card associated with the credit cardholder device 54-58.

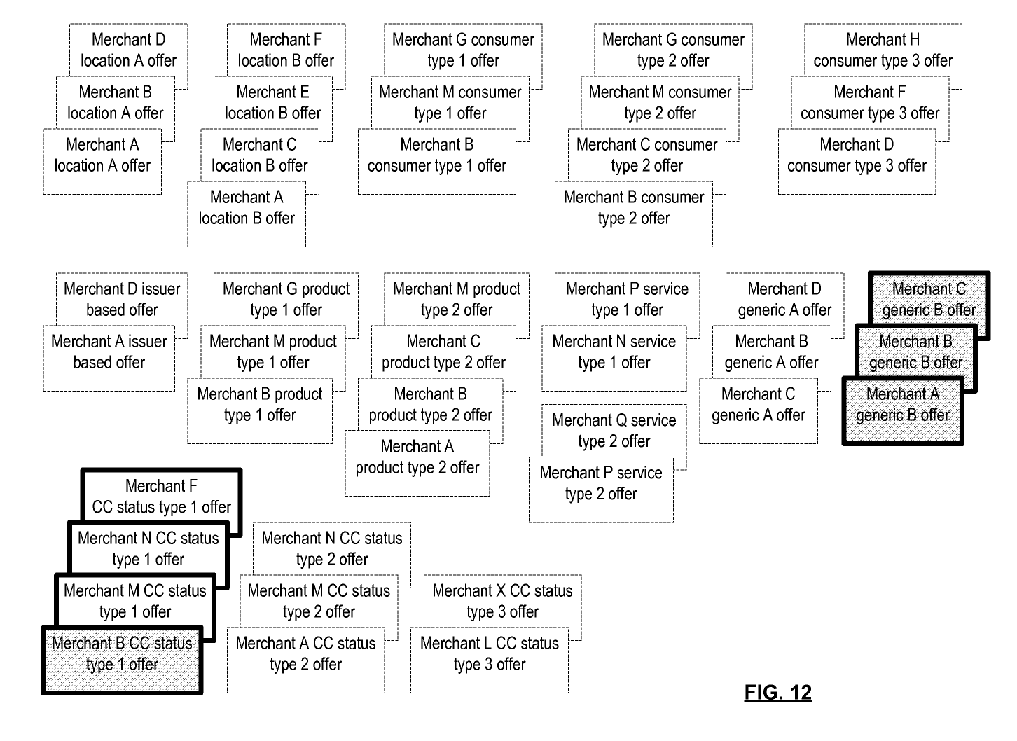

FIG. 13 is a diagram of an example of issuer selected offers made available to a third group of transactional cards, which is of a higher status than the first and second groups. In this example, the issuer device is allowing offers to be selected by cardholders of a card in the third group of transactional cards. The available offers are shown with bold lines while unavailable offers, features, and services are shown with light-dashed lines. In addition, generic offer types A and B are not available due to a conflict with one or more other groupings of offers. For example, the generic offers may conflict (e.g., be redundant or not allowed) with the merchant-issuer based offers.

The selections of available offers are provided to the transactional processing entity device 12 along with the identity of the issuer and the card information regarding the transactional cards in the third group. The transactional processing entity device 12 stores this information and awaits communication from a cardholder device 54-58 associated with a card in the third group.

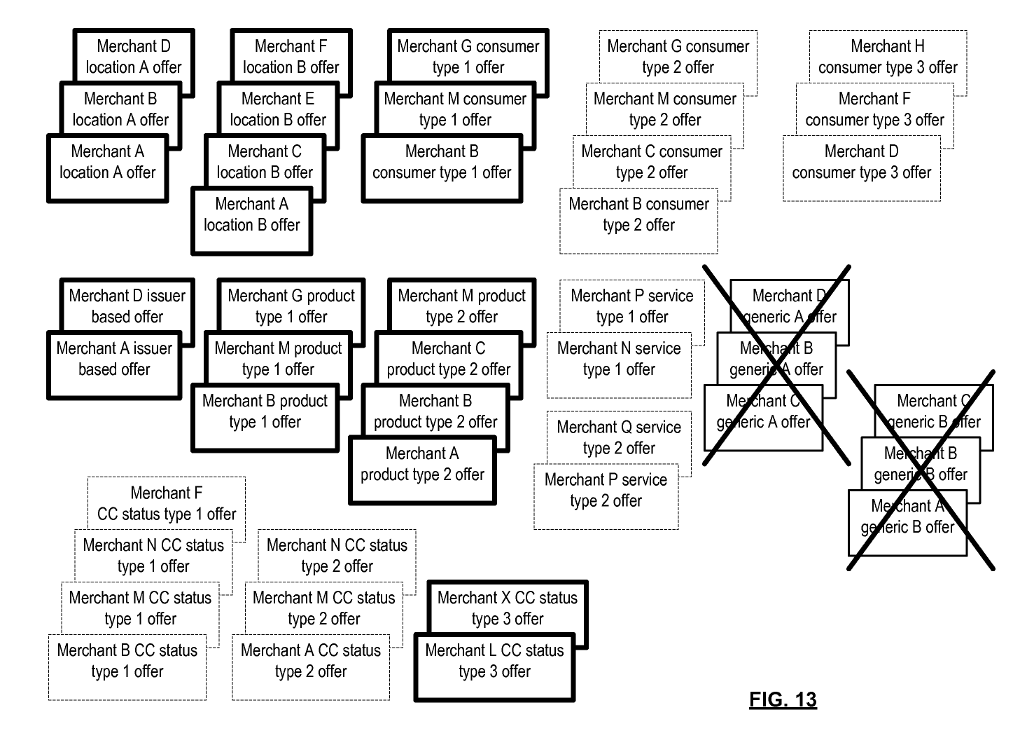

FIG. 14 is a diagram of an example of selected offers made by a card holder of the third group of transactional cards. In this example, a cardholder device 54-58 is communicating with the transactional processing entity device 12 to select one or more of the available offers. In this example, the gray shaded offers have been selected via the credit cardholder device 54-58. The transactional processing entity device 12 stores the selections for use when processing transactions of the card associated with the credit cardholder device 54-58. As an alternative, the transactional processing entity device 12 may generate the available offers for the issuer based on group specific offer criteria and provide the available offers to the issuer device.

FIG. 15 is a schematic block diagram of an embodiment of an issuer device 32-38 that includes a processing module 60, memory 62, and an input/output module 64. The input/output module 64 provides one or more input interfaces and one or more output interfaces for the processing module 60. The input interface may be for receiving inputs from a user via a mouse, keyboard, graphical user interface or other type of human-computer input mechanism. In addition, the input interface may be an input portion of a network card for receiving data from the proprietary network 16 and/or from the network 52. The output interface may be for providing data to a user via a monitor, printer, email, web browser, etc. In addition, the output interface may be on output portion of a network card for transmitting data to the proprietary network 16 and/or to the network 52.

The processing module 60 may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module 60 may have an associated memory 62 and/or an embedded memory element, which may be a single memory device, a plurality of memory devices, and/or embedded circuitry of the processing module. Such a memory device may be a read-only memory, random access memory, volatile memory, non-volatile memory, static memory, dynamic memory, flash memory, cache memory, and/or any device that stores digital information. Note that when the processing module 60 implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Further note that, the memory element stores, and the processing module executes, hard coded and/or operational instructions corresponding to at least some of the steps and/or functions illustrated in FIGS. 1-20.

FIG. 16 is a logic diagram of an embodiment of a method that begins at step 70 where the issuer device determines option criteria for a group of transactional cards. The options criteria includes one or more product categories (e.g., apparel, sports, fitness, etc.), one or more service categories (e.g., food service, legal, accounting, etc.); one or more consumer types (e.g., males age 35-50, females age 35-50, golfers, tennis players, travel enthusiasts, etc.); one or more locations (e.g., within a particular city, county, state, at a particular store, etc.); one or more specific merchants (e.g., Merchant A; Merchant B, etc.); one or more merchant types (e.g., sporting goods, legal services, apparel, shoes, fitness, etc.); and/or one or more credit card status (e.g., pre-paid, single use, personal, business, gold, platinum, etc.). The method continues at step 72 where the issuer device provides the option criteria to a transactional processing entity device.

The method continues at step 74 where the issuer device receives a plurality of options from the transaction processing entity device. The transactional processing entity device creates the options in accordance with the option criteria, where the options includes one or more merchant offers, one or more transactional processing entity services, and/or one or more issuer features. FIGS. 3 and 10 show various examples of options made available to the issuer device.

The method continues at step 76 where the issuer device processes a selection of at least one of the plurality of options to create an options data file for the group of transactional cards. For example, the issuer device receives a selection message that identifies a particular options being selected (e.g., point and click feature of a graphical user interface, a series of keyboard strokes, etc.). As selections are made, the issuer device stores the selected options and individually or in a group transmits them to the transactional processing entity device. The issuer device provides the stored selected options as an options data file to the transactional processing entity device at step 78.

The resulting options data file contains options that individual card holders in the group of transactional cards may select for their respective cards. Examples of various options data files are shown in FIGS. 4, 6, 8, 11, and 13.

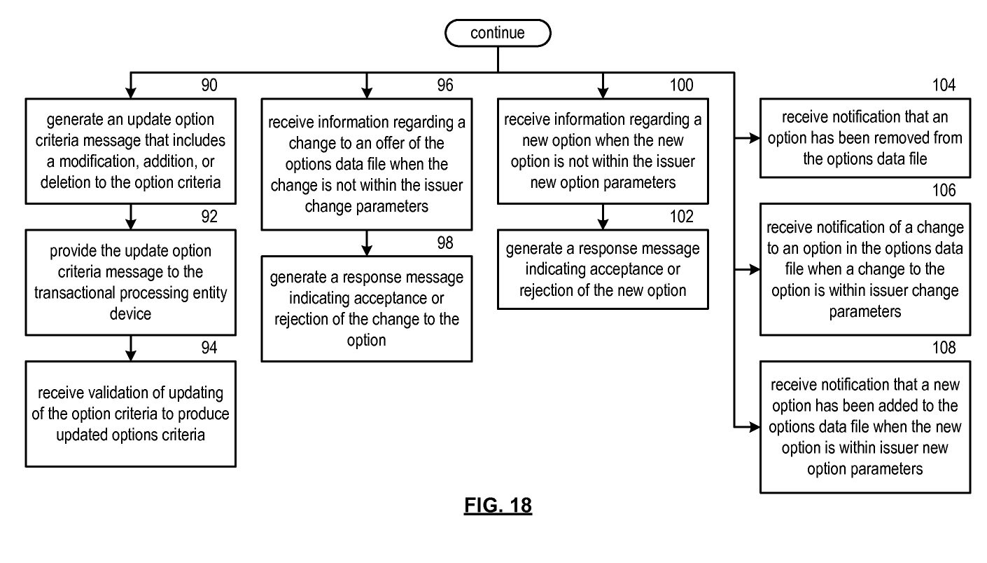

FIG. 17 is a logic diagram of a further embodiment of a method that may be a continuation of the method of FIG. 16. The method of FIG. 17 begins at step 80 where the issuer device receives an invalid options message from the transactional processing entity device in response to providing the options data file. The method continues at step 82 where the issuer device determines whether the invalid options message identifies at least one invalid option. When the message identifies at least one invalid option (e.g., not compatible with another select option, not valid for this issuer, not valid for this group of cards, etc.), the method continues at step 84 or step 86.

At step 84, the issuer device provides a request for validation of the at least one invalid option. In this instance, the issuer device is requesting that the transactional processing entity device either grant permission if the invalid option relates to an transactional processing entity feature or request permission from a merchant device when the invalid option is a merchant offer. Note that the issuer device may resolve invalid issuer features with or without involvement of the transactional processing entity device. If the request is denied, the invalid option is removed from the options data file. If the request is granted, the option is added to the options data file.

At step 86, the issuer device may request deletion of the at least one invalid option from the options data file. In this instance, the issuer device generates a message that includes a request for deletion of the message and transmits it to the transactional processing entity device.

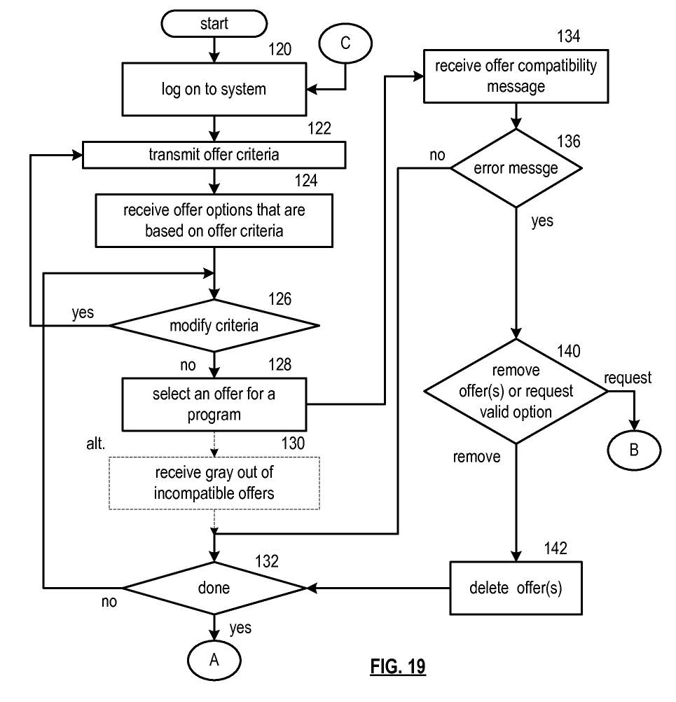

FIG. 18 is a logic diagram of another embodiment of a method that may be a continuation of the method of FIG. 16. The method of FIG. 18 begins at one of steps 90, 96, 100, 140, 106, or 108. At step 90, the issuer device generates an update option criteria message that includes a modification, addition, or deletion to the option criteria. In this instance the issuer device has received a user message via a graphical user interface or other human-computer interface mechanism to change the options criteria for one or more groups of transactional cards. The issuer device processes the user message to produce the update option criteria message.

The method continues at step 92 where the issuer device provides the update option criteria message to the transactional processing entity device. For example, the message may be packetized and transmitted as packets via the proprietary network 16 to the transactional processing entity device. The method continues at step 94 where the issuer device receives validation of updating of the option criteria to produce updated options criteria. For example, the transactional processing entity device processes the message and, if the request to add or modify an option is valid, the transactional processing entity device updates the options criteria accordingly. For deletion requests, the transactional processing entity device may process them without a validation step. Once the message is processed, the transactional processing entity device transmits the validation of the updating.

At step 96, the issuer device receives information regarding the change to the offer of the options data file when the change is not within the issuer change parameters. In this instance, the transactional processing entity device is processing an automatic or manual updating of the options data file. When the transactional processing entity device identifies an option in the options data file that has been modified (e.g., a merchant changes an offer from 10% off to 5% off), the transactional processing entity device determines whether the modified option is within the issuer's change parameters. If the modified option is within the parameters, it is added to the options data file. If not, a message is sent to the issuer device. Note that the issuer change parameters indicate the conditions under which changes to options can be automatically changed in the offer program file and which changes should be brought to the attention of the issuer device such that the issuer device may provide the response as to whether the change is to be accepted or the changed option is to be deleted. For example, if the change affects valid dates for a coupon type offer, then such changes may be automatically updated. As another example, if the change affects the amount of a cash back program, the issuer may want to decide whether to accept such a change.

The method continues at step 98 where the issuer device generates a response message indicating acceptance or rejection of the change to the option. The issuer device transmits the response message to the transactional processing entity device, which updates the issuer device's options data file.

At step 100, the issuer device receives information regarding a new option when the new option is not within the issuer change parameters. In this instance, the transactional processing entity device is processing an automatic or manual updating of the options data file. When the transactional processing entity device identifies a new option that is in accordance with the option criteria, the transactional processing entity device determines whether new or modified option is within the issuer's new options parameters. If the new option is within the parameters, it is added to the options data file. If not, a message is sent to the issuer device. Note that the issuer new options parameters indicate the conditions under which new options can be automatically added to the options data file and which new options should be brought to the attention of the issuer device such that the issuer device may provide the response as to whether the new option is to be added to the options data file.

The method continues at step 102 where the issuer device generates a response message indicating acceptance or rejection of the new option. The issuer device transmits the response message to the transactional processing entity device, which updates the issuer device's options data file.

At step 104 the issuer device receives notification that an option has been removed from the options data file. At step 106 the issuer device receives notification of a change to an option in the options data file when a change to the option is within issuer change parameters. At step 108 the issuer device receives notification that a new option has been added to the options data file when the new option is within issuer new option parameters.

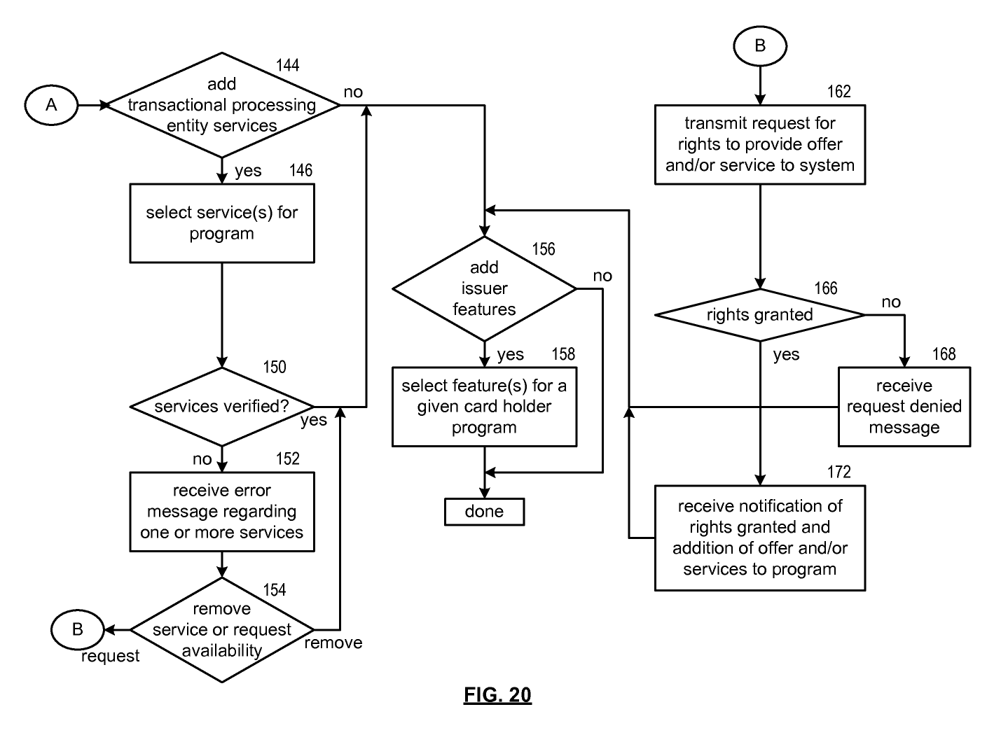

FIGS. 19 and 20 are a logic diagram of another embodiment of a method that begins at step 120 where the issuer device logs onto the system (i.e., establishes communication with the transactional processing entity device). The method continues at step 122 where the issuer device transmits its offer criteria to the transactional processing entity device. The options criteria includes one or more product categories (e.g., apparel, sports, fitness, etc.), one or more service categories (e.g., food service, legal, accounting, etc.); one or more consumer types (e.g., males age 35-50, females age 35-50, golfers, tennis players, travel enthusiasts, etc.); one or more locations (e.g., within a particular city, county, state, at a particular store, etc.); one or more specific merchants (e.g., Merchant A; Merchant B, etc.); one or more merchant types (e.g., sporting goods, legal services, apparel, shoes, fitness, etc.); and/or one or more credit card status (e.g., pre-paid, single use, personal, business, gold, platinum, etc.).

The method continues at step 124 where the issuer device receives offer options from the transactional processing entity device. In an embodiment, the transactional processing entity device creates the options in accordance with the option criteria, where the options includes one or more merchant offers, one or more transactional processing entity services, and/or one or more issuer features. FIGS. 3 and 10 show various examples of options made available to the issuer device.

The method continues at step 126 where the issuer device determines whether to modify the options criteria. For example, the issuer device may desire to reduce the number of the received offer options. If so, the method reverts to step 122. If not, the method continues with the issuer device entering a loop that begins at step 128 where the issuer device processing selection of an offer from the offer options to produce a selected offer. For example, processing a graphical user interface input that identifies the offer. The loop continues with the issuer device providing the selected offer to the transaction processing entity device. The loop continues at step 134 where the issuer device receives an indication when the selected offer does not pass a compatibility check with at least one of: a previously selected offer and a remaining offer of the offer option.

When the offer passes the compatibility check, the method continues at step 132 where the issuer device stores the selected offer to produce a stored offer and determines whether to exit the loop based on a designated stimulus. The designated stimulus may be exhaustion of the offer options, a certain number of offers have been selected, etc. If the loop is existed, the method continues with the issuer device facilitating generation of an offer program file for a group of cards based on one or more of the stored offers. If the loop is not to be exited, the method continues at step 126.

If the selected offer did not pass the compatibility check, the method continues at step 140 where the issuer device determines whether to remove the offer from the options data file of to request validation. If the decision is to delete the offer, the method continues at step 142 where the issuer device deletes the offer from its copy of the options data file and the method continues at step 132. If the decision is request validation, the method continues at step 162 of FIG. 20, which will be described below.

In the alternative, the compatibility check may cause available options to be grayed out preventing subsequent selection at step 130. For example, if the selected option is not compatible with an unselected and available offer of the offer options, the issuer device will receive a message instructing it to prohibit selection of the unselected and available offer (e.g., gray it out on a graphical user interface or rejecting selection of the unselected and available offer).

The method continues at step 144 of FIG. 20, the issuer device determines whether to add transactional processing entity services to the offer program file. If not, the method continues at step 156. If yes, the method continues at step 146 where the issuer device processes selection of one or more services. If the selected one or more services are verified, they are added to the offer program file and the method continues at step 156 via step 150. If the one or more services are not verified, the method continues at step 152 via step 150.

At step 152, the issuer device receives an error message indicating that the one or more services were not verified (i.e., not compatible with one or more previously selected services and/or offers). The message may further include a request for feedback as to whether issuer device would like to request that the select service be made available or to not add it to the program file. If the response is to not add it (or remove it), the selected service is not added to the offer program file and the method continues at step 156.

If the response is to request availability (e.g., remove the compatibility restriction), the method proceeds to step 162 where the issuer device transmits a request for rights to the offer and/or service. The method proceeds to step 166 where, if the rights are granted, the method branches to step 172 and, if the rights are not granted, the method branches to step 168. At step 168, the issuer device receives a message indicating that the request was denied. The method then continues at step 156. At step 172 the issuer device receives notification of the request being granted and that the offer or service is added to the options data file.

At step 156, the issuer device determines whether to add issuer features to the offer program list. If not, the method is complete. If yes, the method continues at step 158 where the issuer device processes selection of one or more features to add to the offer program file or the options data file. After adding the one or more features to the offer program list, the method is complete,

The method of FIGS. 19 and 20 may further include a method where the issuer device receives, via an input interface, a change message regarding at least one offer of the offer program file. Such a method continues with the issuer device processing the change message to accept or reject a change to the at least one offer to produce a change response. The method continues with the issuer device providing the change response to the transactional processing entity device. The method continues with the issuer device receiving a new offer message regarding a new offer. The method continues with the issuer device processing the new offer message to accept or reject the new offer to produce a new offer response. The method continues with the issuer device providing the new offer response to the transactional processing entity device.

As may be used herein, the terms “substantially” and “approximately” provides an industry-accepted tolerance for its corresponding term and/or relativity between items. Such an industry-accepted tolerance ranges from less than one percent to fifty percent and corresponds to, but is not limited to, component values, integrated circuit process variations, temperature variations, rise and fall times, and/or thermal noise. Such relativity between items ranges from a difference of a few percent to magnitude differences. As may also be used herein, the term(s) “coupled to” and/or “coupling” and/or includes direct coupling between items and/or indirect coupling between items via an intervening item (e.g., an item includes, but is not limited to, a component, an element, a circuit, and/or a module) where, for indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”. As may even further be used herein, the term “operable to” indicates that an item includes one or more of power connections, input(s), output(s), etc., to perform one or more its corresponding functions and may further include inferred coupling to one or more other items. As may still further be used herein, the term “associated with”, includes direct and/or indirect coupling of separate items and/or one item being embedded within another item. As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1.

The present invention has also been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claimed invention.

The present invention has been described above with the aid of functional building blocks illustrating the performance of certain significant functions. The boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality. To the extent used, the flow diagram block boundaries and sequence could have been defined otherwise and still perform the certain significant functionality. Such alternate definitions of both functional building blocks and flow diagram blocks and sequences are thus within the scope and spirit of the claimed invention. One of average skill in the art will also recognize that the functional building blocks, and other illustrative blocks, modules and components herein, can be implemented as illustrated or by discrete components, application specific integrated circuits, processors executing appropriate software and the like or any combination thereof.

What is claimed is:

1. A method comprises:
determining option criteria for a group of transactional cards;
providing the option criteria to a transactional processing entity device;
receiving, from the transaction processing entity device, a plurality of options that are in accordance with the option criteria;
processing a selection of at least one of the plurality of options to create an options data file for the group of transactional cards; and
providing the options data file to the transactional processing entity device.

2. The method of claim 1, wherein the option criteria comprises at least one of:
product category;
service category;
consumer type;
location;
specific merchant;
merchant type; and
credit card status.

3. The method of claim 1 further comprises:
receiving invalid options message in response to providing the options data file, wherein the invalid options message identifies at least one invalid option;
in response to the invalid options message, performing at least one of:
providing a request for validation of the at least one invalid option; and
deleting the at least one invalid option from the options data file.

4. The method of claim 1, wherein the plurality of options comprises at least one of:
merchant offers;
transactional processing entity services; and
issuer features.

5. The method of claim 1 further comprises:
generating an update option criteria message that includes a modification, addition, or deletion to the option criteria;
providing the update option criteria message to the transactional processing entity device; and
receiving validation of updating of the option criteria to produce updated options criteria.

6. The method of claim 1 further comprises at least one of:
receiving notification that an option has been removed from the options data file;
receiving notification of a change to an option in the options data file when a change to the option is within issuer change parameters; and
when the change is not within the issuer change parameters:
receiving information regarding the change to the offer of the options data file; and
generating a response message indicating acceptance or rejection of the change to the option.

7. The method of claim 1 further comprises at least one of:
receiving notification that a new option has been added to the options data file when the new option is within issuer new option parameters; and
when the new option is not within the issuer new option parameters:
receiving information regarding the new option; and
generating a response message indicating acceptance or rejection of the new option.

8. A method comprises:
receiving offer options from a transactional processing entity device;
entering a loop, wherein the loop includes:
processing selection of an offer of the offer options to produce a selected offer;
providing the selected offer to the transaction processing entity device;
receiving an indication when the selected offer does not pass a compatibility check with at least one of: a previously selected offer and a remaining offer of the offer options; and
storing the selected offer to produce a stored offer when the compatibility check is favorable;
exiting the loop when a designated stimulus is detected; and
facilitating generation of an offer program file for a group of cards based on one or more of the stored offers.

9. The method of claim 8, wherein receiving the indication of the compatibility check further comprises:
receiving another indication when the selected offer passes the compatibility check;
in response to receiving the indication that the selected offer did not pass the compatibility check, performing at least one of:
prohibiting selection of the selected offer;
rejecting selection of the selected offer; and
requesting authorization to allow compatibility of the selected offer with the one or more previously selected offers.

10. The method of claim 8, wherein the receiving the offer options further comprises:
generating offer criteria that includes at least one of: product category, service category, specific merchants, merchant types, location, credit card status, consumer type, and offer types; and
providing the offer criteria to the transactional processing entity device, wherein the offer options are generated in accordance with the offer criteria.

11. The method of claim 8 further comprises at least one of:
processing selection of at least one transactional processing entity service for inclusion in the offer options; and
processing selection of at least one issuer feature for inclusion in the offer options.

12. The method of claim 8 further comprises:
receiving a change message regarding at least one offer of the offer program file;
processing the change message to accept or reject a change to the at least one offer to produce a change response;
providing the change response to the transactional processing entity device;
receiving a new offer message regarding a new offer;
processing the new offer message to accept or reject the new offer to produce a new offer response; and
providing the new offer response to the transactional processing entity device.

13. An apparatus comprises:
a processing module; and
memory coupled to the processing module, wherein the processing module functions to:
determine option criteria for a group of transactional cards;
provide the option criteria to a transactional processing entity device;
receive, from the transaction processing entity device, a plurality of options that are in accordance with the option criteria;
process a selection of at least one of the plurality of options to create an options data file for the group of transactional cards; and
provide the options data file to the transactional processing entity device.

14. The apparatus of claim 13, wherein the option criteria comprises at least one of:
product category;
service category;
consumer type;
location;
specific merchant;
merchant type; and
credit card status.

15. The apparatus of claim 13, wherein the processing module further functions to:
receive an invalid options message in response to providing the options data file, wherein the invalid options message identifies at least one invalid option;
in response to the invalid options message, perform at least one of:
providing a request for validation of the at least one invalid option; and
deleting the at least one invalid option from the options data file.

16. The apparatus of claim 13, wherein the plurality of options comprises at least one of:
merchant offers;
transactional processing entity services; and
issuer features.

17. The apparatus of claim 13, wherein the processing module further functions to:
generate an update option criteria message that includes a modification, addition, or deletion to the option criteria;
provide the update option criteria message to the transactional processing entity device; and
receive validation of updating of the option criteria to produce updated options criteria.

18. The apparatus of claim 13, wherein the processing module further functions to perform at least one of:
receiving notification that an option has been removed from the options data file;
receiving notification of a change to an option in the options data file when a change to the option is within issuer change parameters; and
when the change is not within the issuer change parameters:
receiving information regarding the change to the offer of the options data file; and
generating a response message indicating acceptance or rejection of the change to the option.

19. The apparatus of claim 13, wherein the processing module further functions to perform at least one of:
receiving notification that a new option has been added to the options data file when the new option is within issuer new option parameters; and
when the new option is not within the issuer new option parameters:
receiving information regarding the new option; and
generating a response message indicating acceptance or rejection of the new option.

20. An apparatus comprises:
a processing module; and
memory coupled to the processing module, wherein the processing module functions to:
receive offer options from a transactional processing entity device;
enter a loop, wherein the loop includes:
processing selection of an offer of the offer options to produce a selected offer;
providing the selected offer to the transaction processing entity device;
receiving an indication when the selected offer does not pass a compatibility check with at least one of: a previously selected offer and a remaining offer of the offer options; and
storing the selected offer to produce a stored offer when the compatibility check is favorable;
exit the loop when a designated stimulus is detected; and
generate an offer program file for a group of cards based on one or more of the stored offers.

21. The apparatus of claim 20, wherein the processing module receiving the indication of the compatibility check further comprises:
receiving another indication when the selected offer passes the compatibility check;
in response to receiving the indication that the selected offer did not pass the compatibility check, performing at least one of:
prohibiting selection of the selected offer;
rejecting selection of the selected offer; and
requesting authorization to allow compatibility of the selected offer with the one or more previously selected offers.

22. The apparatus of claim 20, wherein the processing module receiving the offer options further comprises:
generating offer criteria that includes at least one of: product category, service category, specific merchants, merchant types, location, credit card status, consumer type, and offer types; and
providing the offer criteria to the transactional processing entity device, wherein the the offer options are generated in accordance with the offer criteria.

23. The apparatus of claim 20, wherein the processing module further functions to perform at least one of:
processing selection of at least one transactional processing entity service for inclusion in the offer options; and
processing selection of at least one issuer feature for inclusion in the offer options.

24. The apparatus of claim 20, wherein the processing module further functions to:
receive a change message regarding at least one offer of the offer program file;
process the change message to accept or reject a change to the at least one offer to produce a change response;
provide the change response to the transactional processing entity device;
receive a new offer message regarding a new offer;
process the new offer message to accept or reject the new offer to produce a new offer response; and
provide the new offer response to the transactional processing entity device.
